(19) United States
(12) Patent Application Publication
(10) Pub. No.: US 2016/0149475 A1
(43) Pub. Date: May 26, 2016

(54) Electromechanical Machine Bearing Replacement Jig

(71) Applicant: HGST Netherlands B.V., Amsterdam (NL)

(72) Inventors: Jerico A Benedicto, Naga City (PH); Hannanel M Gallentes, Kabankalan City (PH); Wilfred L Gimena, Las Pinas City (PH); Alvin M Palomo, Malvar (PH)

(21) Appl. No.: 14/552,480

(22) Filed: Nov. 24, 2014

(51) Int. Cl. H02K 15/00

(52) U.S. Cl. CPC H02K 15/0006

(57) ABSTRACT

An electromechanical machine bearing replacement jig, which may be used for refurbishing machines such as motors and/or generators, comprises a housing that includes a bearing hanger configured to hold or support a bearing. A pusher pin is configured to physically interact with a shaft of the machine and an associated lever is configured to apply force to the shaft via the pusher pin while the bearing remains held by the bearing hanger, thus decoupling the two parts. The bearing replacement jig may also be used to attach a replacement bearing to an electromechanical machine by positioning a bearing in a bearing bed where it is held for mating with a shaft of the machine. The shaft is then guided into a mating position with the bearing and the lever pulled down to apply force to the shaft via the pusher pin, thereby forcing the shaft into coupling with the bearing.

### FIELD OF EMBODIMENTS

Embodiments of the invention may relate generally to manufacturing tooling and more particularly to a bearing replacement jig for use in overhauling an electromechanical machine.

### BACKGROUND

Thin-film manufacturing technologies and processes are commonly utilized in the production of various computing and electronics devices, such as for the fabrication of read/write heads for hard disk drives. Some thin-film processes involve the use of photolithography, a process used to pattern parts of a thin film, for example. The photolithography process uses light to transfer a pattern from a photomask to a light-sensitive chemical photoresist on the target. The exposure to light causes a chemical change that allows some of the photoresist to be removed by a special solution referred to as a developer because of its functional similarity to a photographic developer.

The developing process commonly uses a high-speed motor to rotate the jobs while dispensing, up to spin-drying. At times the high-speed motor experiences problems with its bearings, such as due to some chemical penetration to the inside of the motor. Consequently, when the motor experiences abnormal rotation, such as due to a fouled bearing, the quality of the developing process may be negatively and undesirably affected. Therefore, an electromechanical machine with a fouled bearing is often disposed of and replaced with a new machine, which is costly and an inefficient use of resources.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF EMBODIMENTS

Embodiments of the invention are directed toward an electromechanical machine bearing replacement jig, which may be used for overhauling electromechanical machines such as motors and/or generators, and related methods for using such a bearing replacement jig in association with a manufacturing environment. The bearing replacement jig comprises a housing that is configured to house an electromechanical machine, where the housing includes a bearing hanger configured to hold or support a bearing. A pusher pin is configured to physically interact with a shaft of the electromechanical machine, and an associated lever is configured to apply force to the shaft via the pusher pin in order to disengage or decouple the bearing from the shaft. That is, the pusher pin pushes down on the shaft while the bearing remains held by the bearing hanger, thus decoupling the two parts.

In addition to being useful for detaching a bearing from an electromechanical machine, according to an embodiment, the bearing replacement jig can be used to attach a (replacement) bearing to an electromechanical machine by positioning a bearing in a bearing bed that is configured to hold a bearing in position for mating with a shaft of the electromechanical machine. The shaft is then guided into a mating position with the bearing held in the bearing bed, and the lever is pulled down to apply force to the shaft via the pusher pin, in order to force the shaft through or into coupling with the bearing in the bearing bed.

Embodiments discussed in the Summary of Embodiments section are not meant to suggest, describe, or teach all the embodiments discussed herein. Thus, embodiments of the invention may contain additional or different features than those discussed in this section. Furthermore, no limitation, element, property, feature, advantage, attribute, or the like expressed in this section, which is not expressly recited in a claim, limits the scope of any claim in any way.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a perspective view illustrating an electromechanical machine bearing replacement jig, according to an embodiment;

FIG. 2 is a front perspective view illustrating the electromechanical machine bearing replacement jig of FIG. 1, according to an embodiment;

FIG. 3 is a flow diagram illustrating a method of detaching an electromechanical machine bearing, according to an embodiment;

FIG. 4 is a front perspective view illustrating the electromechanical machine bearing replacement jig of FIG. 1 in use, according to an embodiment; and

FIG. 5 is a flow diagram illustrating a method of attaching an electromechanical machine bearing, according to an embodiment.

### DETAILED DESCRIPTION

An electromechanical machine bearing replacement jig is described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### INTRODUCTION

Through use, electromechanical machines such as motors and generators are likely to experience problems with their bearings, and the quality of the operation for which the machine is used may be negatively and undesirably affected. Therefore, an electromechanical machine with a fouled bearing is often disposed of and replaced with a new one, which is costly and an inefficient use of resources. However, the machine may be used again if overhauled, such as when the bearings are simply replaced, rather than disposing of the entire machine. But, detaching and attaching bearings on each end of an armature shaft, for example, can be difficult, challenging procedure. Thus, a tool for replacing bearings simply and efficiently is desirable.

### A Machine Bearing Replacement Jig

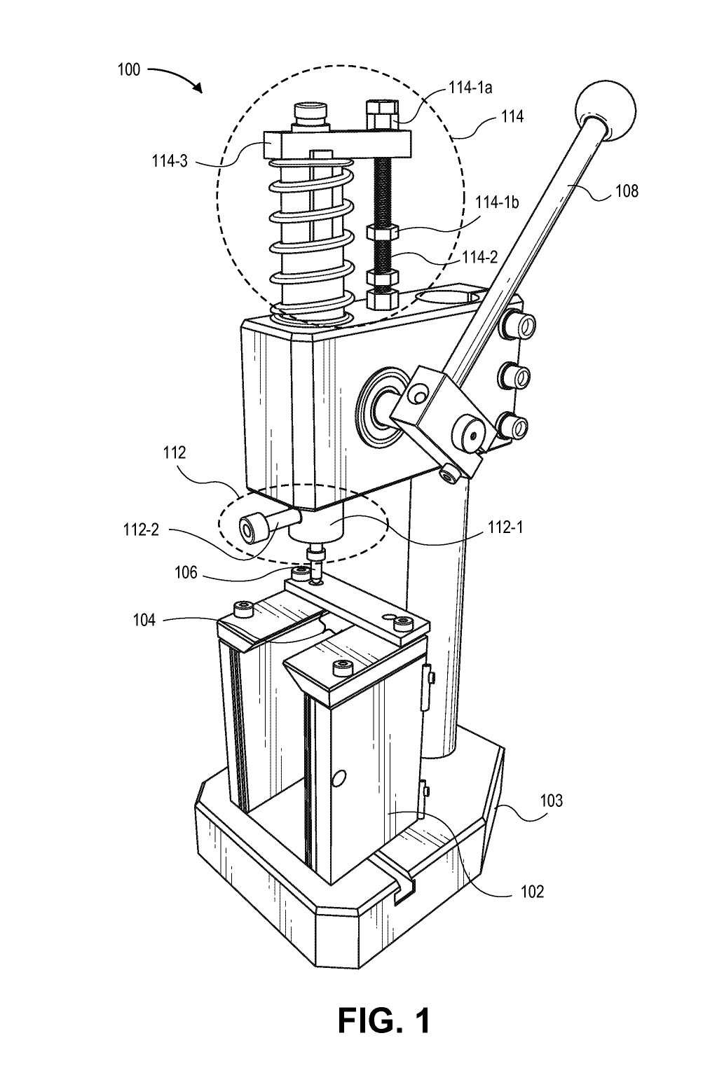

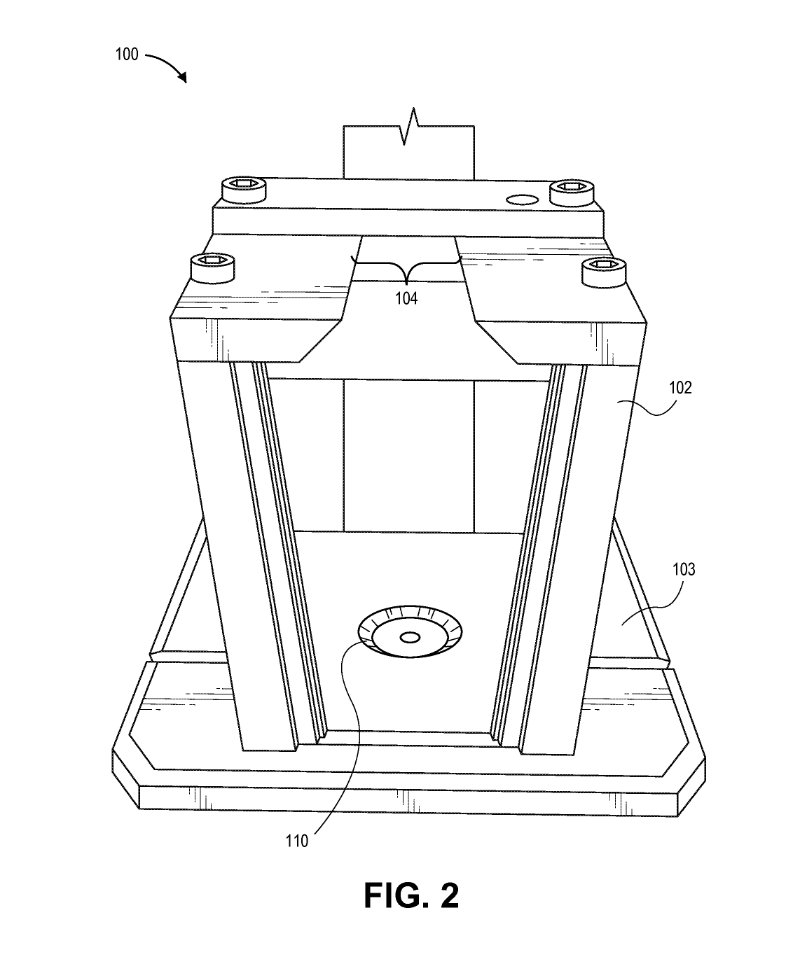

FIG. 1 is a perspective view illustrating an electromechanical machine bearing replacement jig, and FIG. 2 is a front perspective view illustrating the electromechanical machine bearing replacement jig of FIG. 1, according to an embodiment.

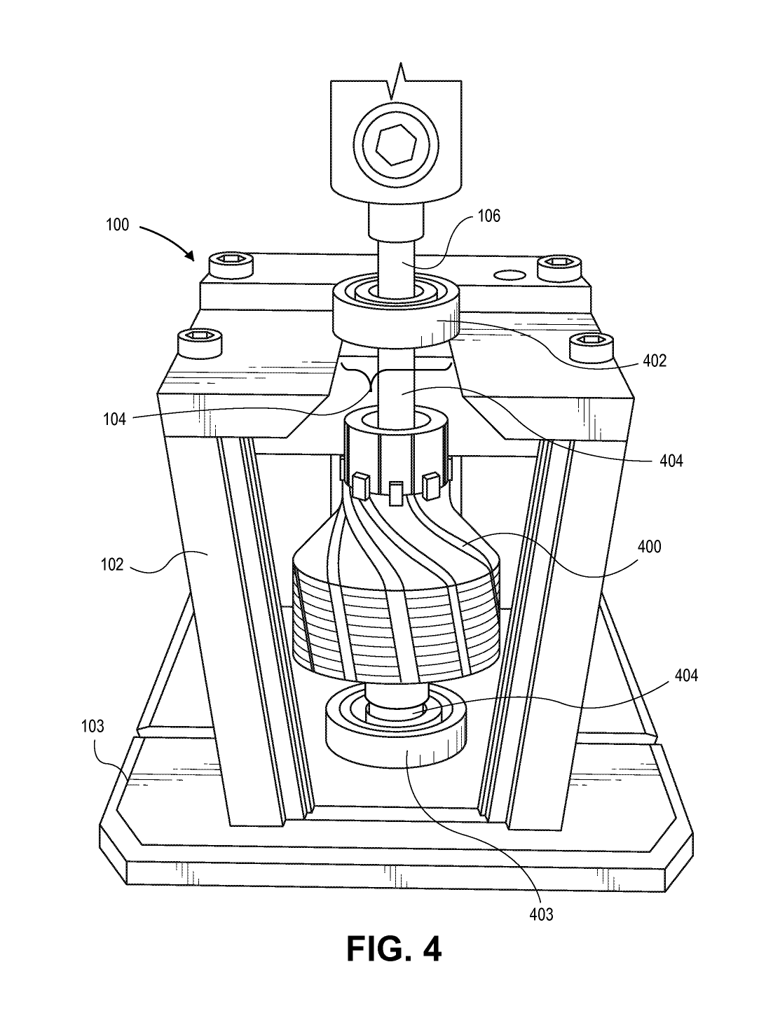

Bearing replacement jig 100 comprises a housing 102 configured to house an electromechanical machine, such as a motor and/or generator (see, e.g., motor 400 of FIG. 4), and attached to a base 103. Housing 102 comprises a bearing hanger 104 configured to hold a machine bearing, such as an armature ball bearing of a motor. According to an embodiment, bearing hanger 104 resembles a gap between two surfaces, such as two planar surfaces. However, the configuration of bearing hanger 104 may vary from implementation to implementation. The configuration of bearing hanger 104 may vary depending on, for example, the type and size of the electromechanical machine and the size of the corresponding bearing, and the like, as long as it is capable of holding a bearing in place while an axial force is applied to a corresponding shaft with which the bearing is coupled. The width of the gap or opening associated with bearing hanger 104 may be adjustable to suit different sizes (e.g., diameters) of bearings.

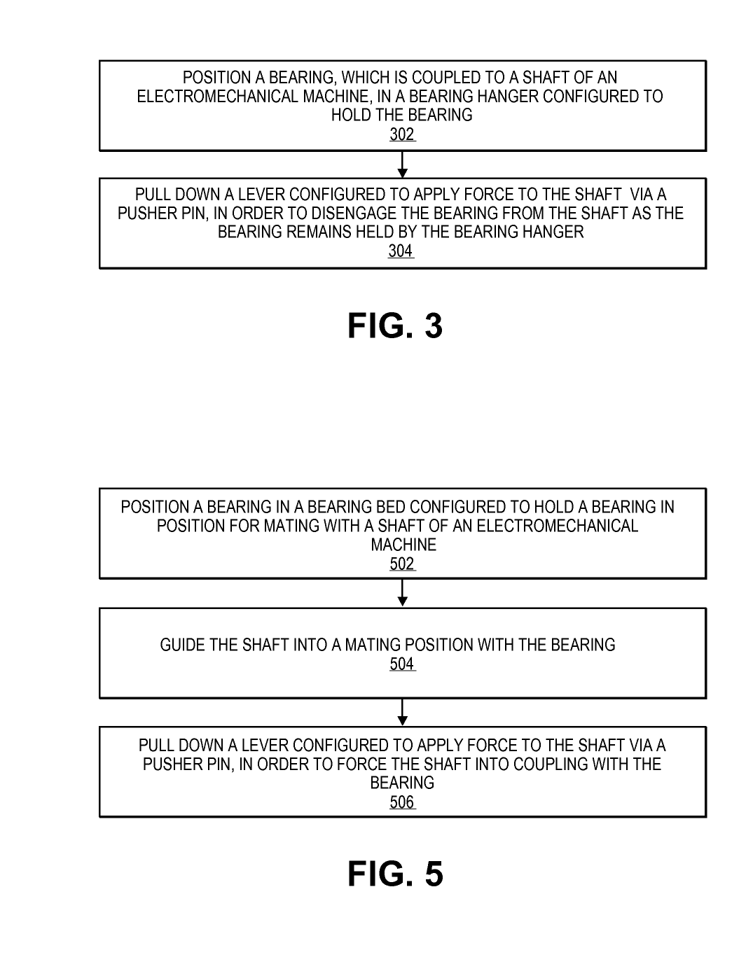

Bearing replacement jig 100 comprises a pusher pin 106 configured to physically interact with a shaft of the electromechanical machine, such as to apply a substantially axial force to the armature shaft of such a machine. Bearing replacement jig 100 comprises a lever 108 configured to apply force, via the pusher pin 106, to a shaft with which a bearing is coupled, such as the armature shaft of the electromechanical machine. Such force is applied to disengage the bearing from the shaft, such as to disengage a motor armature bearing from a armature shaft. A method of detaching a bearing from an electromechanical machine shaft is described in reference to FIG. 3.

With reference to FIG. 2 and according to an embodiment, bearing replacement jig 100 further comprises a bearing bed 110 configured to hold a bearing in position for mating with a shaft, such as to hold an armature bearing in line to mate with a motor armature shaft. According to an embodiment, the bearing bed 110 is positioned at, near or towards the bottom of the housing 102. According to an embodiment, bearing bed 110 is configured as a recessed receptacle at the bottom of housing 102, thus capable of holding a bearing in place when positioned within such a recessed receptacle. A method of attaching a bearing to an electromechanical machine shaft is described in reference to FIG. 4.

Returning to FIG. 1, and according to an embodiment, bearing replacement jig 100 further comprises a pin height adjuster 112 configured to secure the adjustable height of the pusher pin 106. Thus, bearing replacement jig 100 is configured with means to adjust to different electromechanical machines having different physical configurations such as different shaft lengths, bearing heights, and the like. Pin height adjuster 112 may be configured such that the pusher pin 106 is able to be moved up and down within a receptacle 112-1 when a securing device 112-2 such as a screw or threaded pin is loosened, and able to be secured within the receptacle 112-1 when the securing device 112-2 is tightened to apply force to a portion of pushing pin within the receptacle 112-1.

According to an embodiment, bearing replacement jig 100 further comprises a lever adjuster 114 configured to secure the adjustable stroke of the lever 108. Thus, bearing replacement jig 100 is configured with means to adjust to different electromechanical machines having different physical configurations such as different shaft lengths, bearing heights, and the like. Lever adjuster 114 may be configured such that a top limiter nut 114-1a and a bottom limiter nut 114-1b are positioned on a threaded shaft 114-2 along which a spring-loaded armature 114-3 translates as it is mechanically coupled or associated with lever 108, and where the full stroke of lever 108 is controlled by and adjustable based on the distance between limiter nut 114-1a and limiter nut 114-1b.

### Detaching a Bearing from an Electromechanical Machine

FIG. 3 is a flow diagram illustrating a method of detaching an electromechanical machine bearing, and FIG. 4 is a front perspective view illustrating the electromechanical machine bearing replacement jig of FIG. 1 in use, both according to embodiments.

At block 302, a bearing that is coupled to a shaft of an electromechanical machine (e.g., a motor or generator) is positioned in a bearing hanger configured to hold the bearing. For example and with reference to FIG. 4, bearing 402, which is coupled to shaft 404 of electromechanical machine 400, is positioned in bearing hanger 104 (FIGS. 1 and 2) of bearing replacement jig 100.

At block 304, a lever configured to apply force to the shaft via a pusher pin is pulled down in order to disengage the bearing from the shaft while the bearing remains held by the bearing hanger. For example and with reference to FIG. 4, lever 108 (FIG. 1) is pulled down to apply force to the shaft 404 (and thus to the electromechanical machine 400, generally) via pusher pin 106 to disengage the bearing 402 from the shaft 404 while the bearing 402 remains held by the bearing hanger 104 (FIGS. 1 and 2) of bearing replacement jig 100. Therefore, the force of lever 108 and pusher pin 106 releases the electromechanical machine 400 from the bearing 402 while the bearing 402 remains held by the bearing hanger 104 portion of bearing replacement jig 100, thereby disengaging the bearing 402 from the electromechanical machine 400. Similarly, the electromechanical machine 400 can be rotated so that the other bearing 403 is held by bearing hanger 104 (e.g., block 302), and the lever 108 pulled to apply force to the other end of the shaft 404 via pusher pin 106 so as to disengage the bearing 403 from the electromechanical machine 400 (e.g., block 304).

### Attaching a Bearing to an Electromechanical Machine

To overhaul, or refurbish, an electromechanical machine that has a fouled bearing so that it is again in operational condition, once the fouled bearing(s) is detached (see, e.g., the method of FIG. 3) then a new bearing(s) can be attached to the electromechanical machine. FIG. 5 is a flow diagram illustrating a method of attaching an electromechanical machine bearing, according to an embodiment.

At block 502, a bearing is positioned into a bearing bed configured to hold a bearing in position for mating with a shaft of an electromechanical machine (e.g., a motor or generator). For example, a new bearing (e.g., bearing 403 of FIG. 4) is placed into bearing bed 110 (FIG. 2) of bearing replacement jig 100 (FIGS. 1 and 2), where it is held into place in the recessed receptacle that is the bearing bed 110, according to an embodiment.

At block 504, the shaft is guided into a mating position with the bearing. For example and with reference to FIG. 4, shaft 404 of electromechanical machine 400 is guided into the housing 102 of bearing replacement jig 100 such that the bottom of shaft 404 is in a position to mate with the new bearing 403. For non-limiting examples, block 504 may be performed manually such as by the hand of a human operator, or automatically such as by a robot or other automated manufacturing machine.

At block 506, a lever configured to apply force to a shaft via a pusher pin is pulled down in order to force the shaft into coupling with the bearing, which is positioned in the bearing bed. For example and with reference to FIG. 4, lever 108 (FIG. 1) is pulled down to apply force to the shaft 404 (and thus to the electromechanical machine 400, generally) via pusher pin 106 to force the shaft 404 to couple with the bearing 403, which is positioned within the bearing bed 110 (FIG. 2) of bearing replacement jig 100. Therefore, the force of lever 108 and pusher pin 106 force fits the shaft 404 of electromechanical machine 400 into the center hole of the new bearing 403, thereby attaching or coupling the bearing 402 to the electromechanical machine 400. Similarly, another new bearing can be inserted into the bearing bed 110 (e.g., block 502), the electromechanical machine 400 rotated and positioned within the housing 102 (e.g., block 504), and the lever 108 pulled again to apply force to the other end of the shaft 404 via pusher pin 106 so as to attach the other new bearing to the electromechanical machine 400 (e.g., block 506).

Based on the foregoing, an electromechanical machine with a fouled bearing can be used again after the fouled bearing replaced, rather than disposing of the entire machine, thereby providing at least a cost savings.

### EXTENSIONS AND ALTERNATIVES

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

What is claimed is:

1. A bearing replacement tool, comprising:
a housing configured to house an electromechanical machine, said housing comprising a bearing hanger configured to hold a bearing;
a pusher pin configured to physically interact with a shaft of said electromechanical machine; and
a lever configured to apply force to said shaft via said pusher pin in order to disengage said bearing from said shaft.

2. The electromechanical machine bearing replacement tool of claim 1, said housing further comprising a bearing bed positioned at the bottom of said housing and configured to hold a bearing in position for mating with a shaft.

3. The electromechanical machine bearing replacement tool of claim 2, wherein said bearing bed is a recessed receptacle.

4. The electromechanical machine bearing replacement tool of claim 1, further comprising a pin height adjuster configured to secure the adjustable height of said pusher pin.

5. The electromechanical machine bearing replacement tool of claim 1, further comprising a lever adjuster configured to secure the adjustable stroke of said lever.

6. The electromechanical machine bearing replacement tool of claim 1, wherein said housing is configured for housing a motor.

7. The electromechanical machine bearing replacement tool of claim 1, wherein said housing is configured for housing a generator.

8. A method of detaching a bearing from an electromechanical machine shaft, using a bearing replacement tool having a bearing hanger, a lever, and a pushing pin, said method comprising:
positioning a bearing, which is coupled to a shaft of said electromechanical machine, in said bearing hanger configured to hold said bearing; and
pulling down said lever configured to apply force to said shaft via said pusher pin, in order to disengage said bearing from said shaft as said bearing remains held by said bearing hanger.

9. The method of claim 8, wherein said electromechanical machine from which said bearing is detached is a motor.

10. The method of claim 8, wherein said electromechanical machine from which said bearing is detached is a generator.

11. A method of attaching a bearing to an electromechanical machine shaft, using a bearing replacement tool having a bearing bed, a lever, and a pushing pin, said method comprising:
positioning a bearing in said bearing bed configured to hold a bearing in position for mating with a shaft of said electromechanical machine;
guiding said shaft into a mating position with said bearing; and
pulling down said lever configured to apply force to said shaft via said pusher pin, in order to force said shaft into coupling with said bearing.

12. The method of claim 11, wherein said electromechanical machine to which said bearing is attached is a motor.

13. The method of claim 11, wherein said electromechanical machine to which said bearing is attached is a generator.
